(19) United States
(12) Patent Application Publication
(10) Pub. No.: US 2010/0308489 A1
(43) Pub. Date: Dec. 9, 2010

(54) METHOD FOR MAKING CARBON NANOTUBE WIRE STRUCTURE

(75) Inventors: CHEN FENG, Beijing (CN); KAI-LI JIANG, Beijing (CN); SHOU-SHAN FAN, Beijing (CN)

Correspondence Address: Altis Law Group, Inc.;ATTN: Steven Reiss, 288 SOUTH MAYO AVENUE, CITY OF INDUSTRY, CA, 91789, US

(73) Assignees: TSINGHUA UNIVERSITY, Beijing (CN); HON HAI PRECISION INDUSTRY CO., LTD., Tu-Cheng (TW)

(21) Appl. No.: 12/621,512

(22) Filed: Nov. 19, 2009

(30) Foreign Application Priority Data
Jun. 4, 2009 (CN) 200910107679.3

(51) Int. Cl. B29C 43/02

(52) U.S. Cl. 264/105; 977/742

(57) ABSTRACT

The present disclosure provides a method for making a carbon nanotube wire structure. A plurality of carbon nanotube arrays is provided. One carbon nanotube film is formed by drawing a number of carbon nanotubes from each of the plurality of carbon nanotube arrays, whereby a plurality of carbon nanotube films is formed. The carbon nanotube films converge at one spot. The carbon nanotube wire structure is formed by treating the carbon nanotube films via at least one of a mechanical method and an organic solvent method.

### RELATED APPLICATIONS

This application claims all benefits accruing under 35 U.S.C. §119 from China Patent Application No. 200910107679.3, filed on Jun. 4, 2009 in the China Intellectual Property Office. The application is also related to copending application entitled, “CARBON NANOTUBE WIRE STRUCTURE AND METHOD FOR MAKING THE SAME”, filed ***⁻ (Atty. Docket No. US24635).

### BACKGROUND

1. Technical Field

The present disclosure relates to carbon nanotube structures and methods for making the same and, particularly, to a carbon nanotube wire structure and method for making the same.

2. Discussion of Related Art

Carbon nanotubes can be composed of a plurality of coaxial cylinders of graphite sheets. Carbon nanotubes have received a great deal of interest since the early 1990s. Carbon nanotubes have interesting and potentially useful electrical and mechanical properties. Due to these and other properties, carbon nanotubes have become a significant focus of research and development for use in electron emitting devices, sensors, transistors, and other devices.

Generally, carbon nanotubes prepared by conventional methods are in particle or powder form. The particle or powder-shaped carbon nanotubes limit the applications of the carbon nanotubes. Thus, preparation of macro-scale carbon nanotube structures has attracted attention.

A carbon nanotube wire structure is one macro-scale carbon nanotube structure. The carbon nanotube wire structure includes a number of carbon nanotubes, and qualifies as a novel potential material which can replace carbon nanofibers, graphite nanofibers, and fiberglass. The carbon nanotube wire structure is used in electromagnetic shield cables, printed circuit boards, special defend garments, and so on.

A typical example is shown and discussed in U.S. Publication. No. 20080170982A, entitled, “FABRICATION AND APPLICATION OF NANOFIBER RIBBONS AND SHEETS AND TWISTED AND NON-TWISTED NANOFIBER YARNS,” published to Baughman, et al. on Jul. 17, 2008. This patent discloses a yarn including nanofibers, and the nanofibers can be carbon nanotubes. The method for making the yarn includes providing a pre-primary assembly, wherein the pre-primary assembly comprises an array of substantially parallel nanofibers, drawing from the pre-primary assembly to provide a primary assembly of the nanofibers having an alignment axis about which twisting can occur, wherein the primary assembly is selected from the group consisting of an aligned array and an array that is converging toward alignment about the alignment axis, and twisting about the alignment axis of said primary assembly to produce a twisted yarn.

However, a diameter of the yarn made by the method is restricted by a scale of the pre-primary assembly. The pre-primary assembly is usually grown on a silicon substrate. A large silicon substrate is difficult to produce using the present silicon technology. Therefore, it is difficult to acquire a large area of the pre-primary assembly. Thus, the yarn twisted by the pre-primary assembly has a small diameter. The mechanical strength and toughness of the yarn is inferior, and thereby limited in application.

What is needed, therefore, is a method for making a carbon nanotube wire structure with a large diameter, superior mechanical strength, and superior toughness.

### BRIEF DESCRIPTION OF THE DRAWINGS

Many aspects of the embodiments can be better understood with references to the following drawings. The components in the drawings are not necessarily drawn to scale, the emphasis instead being placed upon clearly illustrating the principles of the embodiments. Moreover, in the drawings, like reference numerals designate corresponding parts throughout the several views.

FIG. 1 is a schematic view of one embodiment of a method for making a carbon nanotube wire structure, wherein a substrate is provided.

FIG. 2 is a schematic side view of the substrate in FIG. 1, wherein a carbon nanotube array grows from the substrate.

FIG. 3 is a schematic view of another embodiment of a method for making a carbon nanotube wire structure.

### DETAILED DESCRIPTION

The disclosure is illustrated by way of example and not by way of limitation in the figures of the accompanying drawings in which like references indicate similar elements. It should be noted that references to “an” or “one” embodiment in this disclosure are not necessarily to the same embodiment, and such references mean at least one.

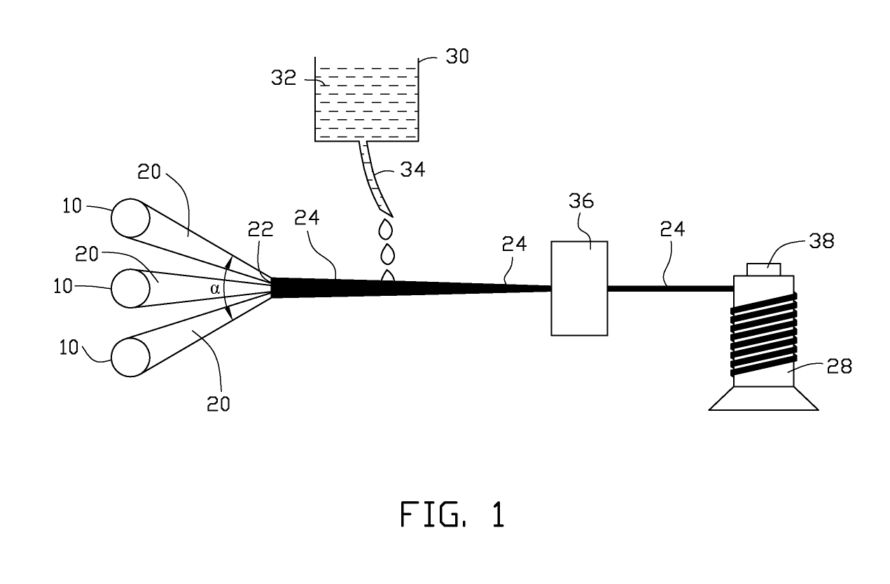

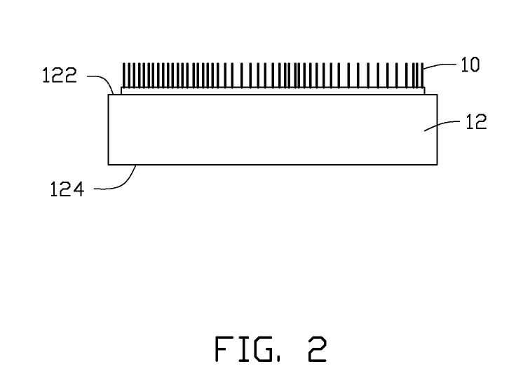

Referring to FIG. 1 to FIG. 2, the one embodiment of a method for making a carbon nanotube wire structure is provided. The method includes:

(S11) providing a plurality of carbon nanotube arrays 10;

(S12) forming one carbon nanotube film 20 by drawing a number of carbon nanotubes from each of the plurality of carbon nanotube arrays 10, whereby a plurality of carbon nanotube films 20 is formed;

(S13) converging the carbon nanotube films 20 at one spot 22; and

(S14) treating the carbon nanotube films 20 by at least one of a mechanical method and an organic solvent method.

In step (S11), each of the carbon nanotube arrays 10 is formed on a substrate 12. The substrate 12 has a first surface 122 and a second surface 124 opposite to the first surface 122. The carbon nanotube array 10 is grown from the first surface 122. The second surfaces 124 of all substrates 12 are coplanar. The substrates 12 can be arranged, for example, in a straight line, a curved line, or a zigzag. The number of the substrates 12 is unrestricted. In one embodiment, the number of the substrates 12 is three. The three substrates 12 are arranged in a straight line.

The carbon nanotube array 10 is composed of a plurality of carbon nanotubes. The plurality of carbon nanotubes can be single-walled carbon nanotubes with diameters of about 0.5 nanometers to about 50 nanometers, double-walled nanotubes with diameters of about 1 nanometer to about 50 nanometers, multi-walled carbon nanotubes with diameters of about 1.5 nanometers to about 50 nanometers, or any combination thereof. In one embodiment, the plurality of carbon nanotubes is multi-walled carbon nanotubes, and substantially parallel to each other. Each carbon nanotube array 10 is essentially free of impurities, such as carbonaceous or residual catalyst particles. Each carbon nanotube array 10 can be a super aligned carbon nanotube array. A method for making the plurality of carbon nanotube arrays 10 is unrestricted, and can be by chemical vapor deposition methods or other methods.

In step (S12), each carbon nanotube film 20 is formed from one carbon nanotube array 10. A method for making the carbon nanotube film 20 includes the following steps. A drawing tool is contacted with a plurality of carbon nanotubes of one carbon nanotube array 10. The carbon nanotube film 20 is formed by stretching a plurality of carbon nanotubes using the drawing tool, along a drawing direction. The drawing direction is away from the carbon nanotube array 10. A first angle can be defined between the drawing direction and the first surface 122 of the substrate 12. The first angle may be more than 0 degrees, and equal to or less than 30 degrees. In one embodiment, the first angle can be from a little more than 0 degrees to 5 degrees. During the drawing process, as the plurality of carbon nanotubes contacting the drawing tool are stretched out, other carbon nanotubes are also stretched out end to end due to the van der Waals attractive force between ends of adjacent carbon nanotubes. The carbon nanotubes in the carbon nanotube film 20 are substantially parallel to the drawing direction of the carbon nanotube film 20. In one embodiment, the drawing tool is an adhesive tap with a certain width. The width of the adhesive tap can be a little more than the plurality of carbon nanotubes contacting the drawing tool, with the first angle at about 5 degrees.

In step (S13), as the plurality of carbon nanotube films 20 is stretched out from the plurality of carbon nanotube arrays 10, each stretched direction can extend from each of the plurality of carbon nanotube arrays 10 to one spot 22. During the stretching process, each carbon nanotube film 20 gradually converges toward one spot 22, until the plurality of carbon nanotube films 20 is finally converged at the spot 22. Since each of the carbon nanotube films 20 is adhesive in nature, the carbon nanotube films 20 can adhere to each other.

During the converging process, second angles are formed between any two of the plurality of carbon nanotube films 20 at the spot 22. A maximum second angle exists between two outmost carbon nanotube films 20. The maximum second angle may be more than 0 degrees, and less than 180 degrees. Furthermore, the maximum angle can be more than 0 degrees and less than or equal to 60 degrees. In one embodiment, the maximum angle is 60 degrees.

In step (S14), the mechanical method can be conducted by twisting the converged carbon nanotube films 20 by a mechanical force to form the carbon nanotube wire structure 24. The converged carbon nanotube films 20 can be fixed at a rotating roller at the spot 22. The rotating roller can be rotated clockwise or counterclockwise. More specifically, during rotation, each of the carbon nanotube films 20 is drawn from each of the plurality of carbon nanotube arrays 10. Then, the carbon nanotube films 20 are twisted clockwise or counterclockwise into the carbon nanotube wire structure 24 by a mechanical force of the roller. In this way, a continuous process of making the carbon nanotube wire structure 20 can be conducted.

The twisted carbon nanotube films 20 can adhere to each other without an adhesive because of their inherent adhesive nature. Thus, it is difficult to discern the individual carbon nanotube film 20 in the carbon nanotube wire structure 24, even when taking a cross section of the carbon nanotube wire structure 24. The carbon nanotube wire structure 24 includes a plurality of successively oriented carbon nanotubes joined end to end by van der Waals attractive force, and the carbon nanotubes are aligned around an axis of the carbon nanotube wire structure 24 like a helix. Length of the carbon nanotube wire structure 24 can be arbitrarily set as desired.

Further, the carbon nanotube wire structure 24 can be treated with a volatile organic solvent 32. An entire surface of the carbon nanotube wire structure 24 can be soaked with the organic solvent 32. The organic solvent 32 can be dropped on the surface of the carbon nanotube wire structure 24 by a dropper 30. In one embodiment, the dropper 30 is positioned upon the surface of the carbon nanotube wire structure 24. The dropper 30 includes an opening 34 in a bottom thereof. The organic solvent 32 can be dropped out from the opening 34 of the dropper 30, drop by drop. The organic solvent 32 can be any volatile fluid, such as ethanol, methanol, acetone, dichloroethane, and chloroform.

In one embodiment, the organic solvent 32 is ethanol. After being soaked by the organic solvent 32 portion by portion, the carbon nanotube wire structure 24 can be tightly shrunk portion by portion, under a surface tension of the organic solvent. The carbon nanotube wire structure 24 treated by the organic solvent 32 includes a plurality of successively oriented carbon nanotubes joined end to end by van der Waals attractive force, and the carbon nanotubes are aligned around the axis of the carbon nanotube wire structure 24 like a helix. It is difficult to discern the individual carbon nanotube films 20 in the carbon nanotube wire structure 24, even when taking a cross section of the organic solvent treated carbon nanotube wire structure 24. The carbon nanotube films 20 are without obvious seams therebetween.

The organic solvent method for making the carbon nanotube wire structure 24 includes the following steps. A pretreated carbon nanotube structure is formed by stacking the plurality of carbon nanotube films 20 at the spot 22. The pretreated carbon nanotube structure is composed of stacked carbon nanotube films 20. The carbon nanotube wire structure 24 is formed by treating the pretreated carbon nanotube structure with an organic solvent (not shown). The method for treating the pretreatment carbon nanotube structure using the organic solvent is similar to the method for treating the carbon nanotube wire structure 24 with the organic solvent 32 in the mechanical method. An entire surface of the pretreated carbon nanotube structure can be soaked with the organic solvent 32. The pretreated carbon nanotube structure can shrink into the carbon nanotube wire structure 24 without being twisted, due to a surface tension of the organic solvent 32. The carbon nanotube wire structure 24 includes a plurality of successively oriented carbon nanotubes joined end to end by van der Waals attractive force, and the carbon nanotubes are substantially parallel to an axis or a length of the carbon nanotube wire structure 24.

In one embodiment, the carbon nanotube wire structure 24 is formed by the mechanical method, and then treated with the organic solvent 32.

Furthermore, the carbon nanotube wire structure 24 can be dried after being treated with the organic solvent 32. In one embodiment, the carbon nanotube wire structure 24 is passed through a drying device 36 portion by portion. The temperature of the drying device 36 can be in a range from about 80 degrees centigrade to about 100 degrees centigrade, thus, the organic solvent 32 in the carbon nanotube wire structure 24 may be volatilized quickly. The carbon nanotubes in the carbon nanotube wire structure 24 are arranged more closely. In another embodiment, the carbon nanotube wire structure 24 is dried with a blow dryer.

The organic solvent treated carbon nanotube wire structure 24 can be easily collected, due to its low viscosity. In one embodiment, the carbon nanotube wire structure 24 is coiled onto a bobbin 28 driven by a motor 38. In another embodiment, the carbon nanotube wire structure 24 is coiled onto the bobbin 28 by hand.

A diameter of the carbon nanotube wire structure 24 is related to the number and size of the carbon nanotube arrays 10. The diameter of the carbon nanotube wire structure 24 can be any diameter, such as about 1 micron or more than 50 microns. In one embodiment, the diameter of the carbon nanotube wire structure 24 is about 130 microns.

It is to be understood that the above-mentioned process for making the carbon nanotube wire structure 24 is a successive process.

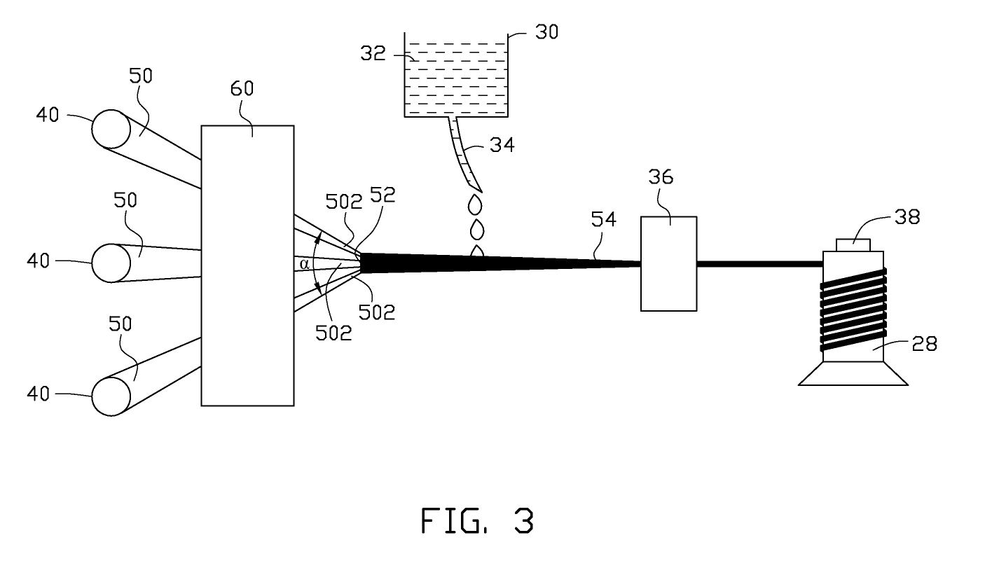

Referring to FIG. 3, another embodiment of a method for making the carbon nanotube wire structure 54. The method includes:

(S21) providing a plurality of carbon nanotube arrays 40;

(S22) forming one carbon nanotube film 50 by drawing a number of carbon nanotubes from each of the plurality of carbon nanotube arrays 40, whereby a plurality of carbon nanotube films 50 is formed;

(S23) forming a plurality of carbon nanotube composite films 502, by applying at least one metal layer on each of the plurality of carbon nanotube films 50;

(S24) converging the carbon nanotube composite films 502 at one spot 52; and

(S25) treating the carbon nanotube composite films 502 by at least one of a mechanical method and an organic solvent method.

Step (S23) can be conducted by physical methods such as physical vapor deposition methods, or chemical methods such as electroplating deposition methods and chemical plating deposition methods. The physical vapor deposition methods include vacuum metallizing deposition methods or ion sputtering deposition methods. A material of the metal layer can be gold, silver, platinum, copper, or an alloy of any combination thereof. A thickness of the metal layer can be in a range from about 1 nanometer to about 20 nanometers. In one embodiment, the plurality of carbon nanotube films 50 passes through a vacuum vessel 60. In the vacuum vessel 60, a copper layer is formed on each of the carbon nanotube films 50 by a vacuum metallizing deposition method. A platinum layer is formed on the copper layer. Therefore, each carbon nanotube composite film 502 includes one carbon nanotube film 50 with the copper layer and the platinum layer deposited thereon. The copper layer is located between the carbon nanotube film 50 and the platinum layer.

In one embodiment, step (S25) is executed by the organic solvent method. A pretreated carbon nanotube composite structure is formed by stacking the plurality of carbon nanotube composite films 502 at the spot 52. The pretreated carbon nanotube composite structure is composed of the plurality of stacked carbon nanotube composite films 502. The carbon nanotube wire structure 54 is formed by treating the pretreated carbon nanotube composite structure with an organic solvent 32. The carbon nanotube wire structure 54 is coiled onto a bobbin 28 driven by a motor 38, after being dried by the drying device 36.

It is difficult to discern the number of the individual carbon nanotube composite film 502 in the carbon nanotube wire structure 54 from a cross section of the carbon nanotube wire structure 54. There are no obvious interfaces between the carbon nanotube composite films 502. The carbon nanotube wire structure 54 is a carbon nanotube composite wire structure. The carbon nanotube wire structure 54 includes a plurality of successively oriented carbon nanotubes joined end to end by van der Waals attractive force. The carbon nanotubes are substantially parallel to an axis or a length of the carbon nanotube wire structure 54, and at least one metal layer is formed on the carbon nanotubes. In one embodiment, the copper layer and the platinum layer are formed on the carbon nanotubes of the carbon nanotube wire structure 54, with the copper layer located between the carbon nanotubes and the platinum layer, and a diameter of the carbon nanotube wire structure 54 of about 200 microns.

The method for making the carbon nanotube wire structure having a desired diameter can be acquired by the present methods according to the size of a single carbon nanotube array. The carbon nanotube wire structure has good thermal and electrical conductivity, excellent toughness, high mechanical strength, and can be readily used in cables, printed circuit boards, cloths, and other macroscopic applications.

It is to be understood that the above-described embodiment is intended to illustrate rather than limit the disclosure. Variations may be made to the embodiment without departing from the spirit of the disclosure as claimed. The above-described embodiments are intended to illustrate the scope of the disclosure and not restricted to the scope of the disclosure.

It is also to be understood that the above description and the claims drawn to a method may include some indication in reference to certain steps. However, the indication used is only to be viewed for identification purposes and not as a suggestion as to an order for the steps.

What is claimed is:

1. A method for making a carbon nanotube wire structure, comprising:
(a) providing a plurality of carbon nanotube arrays;
(b) forming a plurality of carbon nanotube films by drawing a plurality of carbon nanotubes from each of the plurality of carbon nanotube arrays;
(c) converging the carbon nanotube films at one spot; and
(d) treating the carbon nanotube films by at least one of a mechanical method and an organic solvent method.

2. The method of claim 1, further comprising a step (e) of forming at least one metal layer on each of the plurality of carbon nanotube films before step (c).

3. The method of claim 2, wherein the step (e) is executed by physical vapor deposition methods, chemical plating deposition methods, or electroplating deposition methods.

4. The method of claim 1, wherein each of the carbon nanotube arrays comprises a substrate, the carbon nanotubes growing from a top of the substrate, a bottom of the substrate of each of the carbon nanotube arrays is coplanar.

5. The method of claim 1, wherein a maximum second angle exists between two outmost carbon nanotube films, the maximum second angle is in a range from about 0 degrees to about 180 degrees.

6. The method of claim 5, wherein the maximum second angle is in a range from about 0 degrees to about 60 degrees.

7. The method of claim 1, wherein step (d) is executed by twisting the converged carbon nanotube films by a mechanical force at the spot.

8. The method of claim 7, further comprising a step of treating the carbon nanotube wire structure with an organic solvent after step (d).

9. The method of claim 8, wherein the carbon nanotube wire structure is dried after treated by the organic solvent.

10. The method of claim 1, wherein the step (d) is conducted by: forming a pretreated carbon nanotube structure by stacking the plurality of carbon nanotube films at the spot; and forming the carbon nanotube wire structure by treating the pretreated carbon nanotube structure with an organic solvent.

11. The method of claim 10, further comprising a step of drying the carbon nanotube wire structure.

12. The method of claim 1, wherein the carbon nanotube wire structure is coiled onto a bobbin.

13. The method of claim 1, wherein the carbon nanotube wire structure comprises a plurality of successive carbon nanotubes joined end to end by van der Waals attractive force therebetween.

14. The method of claim 13, wherein the carbon nanotubes are substantially parallel to a length of the carbon nanotube wire structure.

15. The method of claim 13, wherein the carbon nanotubes are spirally aligned around an axis of the carbon nanotube wire structure.

16. The method of claim 13, wherein a diameter of the carbon nanotube wire structure is more than 50 microns.

17. A method for making a carbon nanotube wire structure, the method comprising:
providing a substrate;
growing a plurality of carbon nanotubes from the substrate;
forming a plurality of carbon nanotube films by pulling the plurality of carbon nanotubes;
converging the carbon nanotube films at one spot, whereby an angle is defined between two outmost carbon nanotube films;
treating the carbon nanotube films by at least one of a mechanical method and an organic solvent method.

18. The method of claim 17, wherein the angle is in a range from about 0 degrees to about 180 degrees.

19. The method of claim 17, wherein a step of forming at least one metal layer on each of the plurality of carbon nanotube films before the step of converging the carbon nanotube films at one spot.

20. A method for making a carbon nanotube wire structure, the method comprising:
providing a plurality of substrates having coplanar bottom surfaces;
growing a plurality of carbon nanotube arrays from the substrates;
drawing a plurality of carbon nanotube films toward a common spot by drawing a plurality of carbon nanotubes from the carbon nanotube arrays;
treating the carbon nanotube films by at least one of a mechanical method and an organic solvent method.
